(19) United States
(12) Patent Application Publication
(10) Pub. No.: US 2012/0204474 A1
(43) Pub. Date: Aug. 16, 2012

(54) Fish holding device for culling fish

(76) Inventor: Adam Mihara, Mt. Laurel, NJ (US)

(21) Appl. No.: 12/932,009

(22) Filed: Feb. 16, 2011

(51) Int. Cl. A01K 97/00

(52) U.S. Cl. 43/55

(57) ABSTRACT

A fish holding device for culling fish has a forward section with an upper member and a lower member and a spring located therebetween having sufficient biasing force for maintaining the lip of a fish between the ends of the upper and lower member when the holding device is in the closed position. The holding device further comprises a rear section for locking the holding device in the closed position. The rear section is connected to the lower member of the forward section and is rotatable between a non-locking position and a locking position over the upper member of the forward section. When the lip of a fish is secured between the upper and lower members of the forward section the rear section is in position over and secured to the upper member of the forward section, the holding device is locked in place on the fish. The only way for the holding device to be removed from the fish is for the fisherman to rotate the rear section away from the forward section and separate the upper and lower members of the forward section by squeezing the holding device against the biasing force of the spring.

### BACKGROUND OF THE INVENTION

Catch and release bass fishing tournaments have become very popular throughout the United States. In these tournaments, the participant is typically required to fish for a given time period of several hours. At the end of this time, the fisherman turns in a designated, maximum number of fish, usually five. The fisherman catching the prescribed number of fish with the greatest total cumulative weight is declared the winner. However, there is often a limit to the number of fish which can be retained by the fisherman at one time; and so it is critical that the lighter fish be quickly and efficiently returned to the water. However, it is also important that the fish which are ultimately placed back in the water are alive and healthy, to be available to be caught another day. Therefore, it is very important for the tournament fishermen to have a quick and easy way of “culling” fish and returning them safely to the water.

Culling fish during a tournament begins when the maximum allowed number of fish have been caught. It constitutes the ongoing process of releasing smaller, lighter fish which would not count towards the fisherman's total weight, and replacing them with larger, heavier fish. In other words, as the fisherman catches bigger fish, he releases, or culls, the smaller fish.

It is important that the health and well being of all fish which are released, both those which are culled and those which are ultimately retained for the tournament, are preserved to the extent possible. In fact, some tournaments impose penalties for fish which perish during the competition.

With these goals in mind, fishermen commonly use livewells to store fish which are caught during the tournament fishing process. Livewells are containers designed to keep fish alive for a given period of time. After a fish is caught, it is weighed and markers or tags are attached to identify the fish and their weights. The fish are then placed in the livewell. When the fisherman/tournament participant has caught five fish, or other maximum prescribed number, the next fish which is caught must be weighed and compared to the weight of the fish already in the livewell. The lighter fish is then taken from the livewell, its marker removed, and it is returned to the water. However, most fish markers require the fisherman to puncture a hole in the fish or run tags through delicate gills. This process is not only lengthy and tedious, but also wastes valuable tournament time. Other systems utilize markers which are clipped onto the fish. However, such markers eventually fall off as the fish swims around the livewell.

### SUMMARY OF THE INVENTION

It is thus the object of the present invention to provide a fish holding device for culling fish which overcomes the disadvantages and limitations of existing fish culling systems.

It is the object of the present invention to provide a fish holding device which is quick and easy to secure onto the fish, while ensuring that the holding device remains on the fish at all times until specifically removed by the fisherman.

It is another object of the present invention to provide a fish holding device which is fish friendly, that is which will not cause harm to the fish both when the holding device is placed on and then removed from the fish.

These and other objects are accomplished by the present invention, a fish holding device for culling fish which comprises a forward section with an upper member and a lower member and a spring located therebetween having sufficient biasing force for maintaining the lip of a fish between the ends of the upper and lower member when the holding device is in the closed position. The holding device further comprises a rear section for locking the holding device in the closed position. The rear section is connected to the lower member of the forward section and is rotatable between a non-locking position and a locking position over the upper member of the forward section. When the lip of a fish is secured between the upper and lower members of the forward section the rear section is in position over and secured to the upper member of the forward section, the holding device is locked in place on the fish. The only way for the holding device to be removed from the fish is for the fisherman to rotate the rear section away from the forward section and separate the upper and lower members of the forward section by squeezing the holding device against the biasing force of the spring.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the fish holding device of the present invention in use on a fish.

FIG. 2 is a perspective view of the fish holding device of the present invention in its closed and locked position.

FIG. 3 is a perspective view of the fish holding device of the present invention with its rear section locked in the open position.

FIG. 4 is an elevation view of the fish holding device shown in FIG. 2.

FIG. 5 is an elevation view of the fish holding device shown in FIG. 3.

### DETAILED DESCRIPTION OF THE INVENTION

Fish holding device 1 of the present invention is an integral unit comprising forward section 2 and rear section 20.

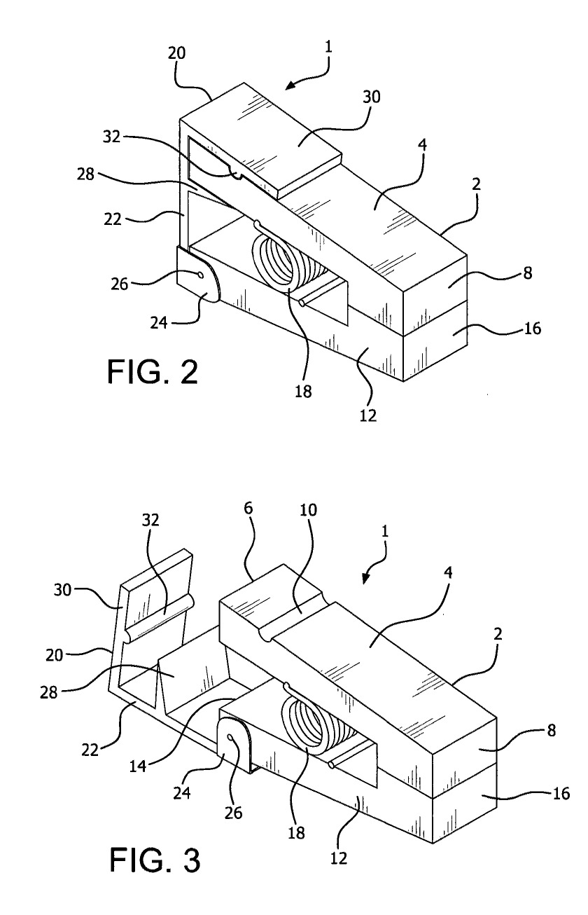

Forward section 2 comprises upper member 4 having rear end 6 and front end 8. Upper member 4 comprises slot 10 nearer to its rear end 6. Forward section 2 also comprises lower member 12 having rear end 14 and front end 16. Coiled spring 18 provides a biasing force which normally compels front end 8 of upper member 4 against front end 16 of lower member 12, when fish holding device 1 is in its closed position, as shown in FIGS. 2-5.

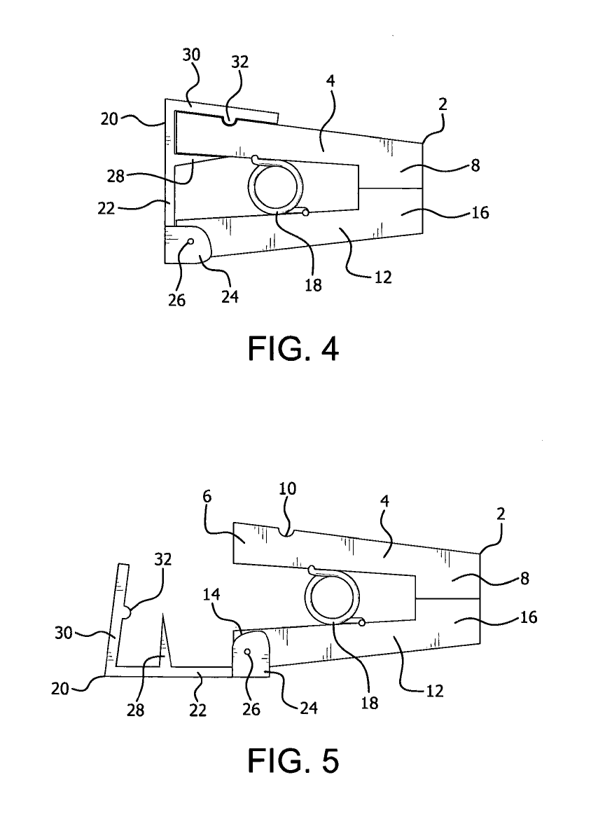

Rear section 20 comprises arm member 22 which is connected to rear end 14 of lower member 12 of forward section 2 via bracket 24. Bracket 24 and rear section 20 are rotatable about forward section 2 via attachment pin 26, extending through rear end 14 of lower member 12. Rear section 20 also comprises second arm member 30 extending up from and angled in relation to arm member 22. Second arm member 30 comprises tab 32 configured to be inserted into slot 10 of upper member 4 of forward section 2. Support member 28 extends up from arm member 22 of rear section 20. It is configured to be positioned beneath rear end 6 of upper member 4 when fish holding device 1 is in its fully closed position, as seen in FIGS. 2 and 4.

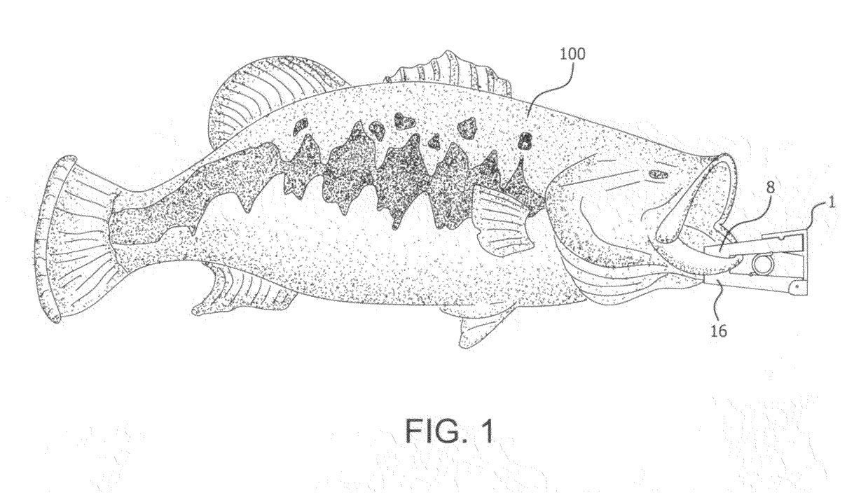

The operation of fish holding device 1 is as follows. In its fully closed position, shown in FIG. 2, spring 18 provides a biasing force to maintain upper member 4 against lower member 12, with rear section 20 located over the upper member to lock holding device 1 in this position. To open holding device 1, the user squeezes rear end 6 of upper member 4 towards rear end 14 of lower member 12, against the biasing force of spring 18. This releases tab 32 from slot 10, permitting rear section 20 to rotate down and away from upper member 4 of forward section 2, as seen in FIG. 3. Rear end 6 and rear end 14 are again squeezed against the biasing force of spring 18 to separate front ends 8 and 16 of forward section 2, allowing the ends to encircle a lip of fish 100. The squeezing pressure on rear ends 6 and 14 is then released and the biasing force of spring 18 compels front ends 8 and 16 around the lip of fish 100. See FIG. 1.

Rear section 20 is then rotated back up towards forward section 2, such that tab 32 is again inserted into slot 10 and support member 28 is compelled against and hugs the lower surface of rear end 6 of upper member 4. This results in fish 100 being secured by holding device 1, within front end 8 of upper member 4 and front end 16 of lower member 12 as a result of the biasing force of spring 18. Holding device 1 is also immoveably locked in this position on fish 100 by the interconnection of rear section 20 on and over upper member 4, via the slot 10 and tab 32 connection and the support member 28 retention.

Fish holding device 1 can be easily and readily removed from fish 100 simply by opening the device, that is rotating rear section 20 back away from forward section 2 and again squeezing rear end 6 towards rear end 14 and separating front ends 8 and 16. Both the connection and removal of fish holding device 1 is not only secure, quick and efficient, but will also not harm the fish in any way.

Fish holding device 1 can also easily be used in conjunction with a fish weighing balance beam or handheld scale. Holding device 1 is simply clipped to the fish to be compared and placed on the balance beam or scale. The process is quick and easy and eliminates the risk of loosing a fish from the beam or scale while it is being weighed.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A fish holding device for use in culling fish comprising:
a forward section having an upper member with a rear end and a front end, a lower member with a rear end and a front end, and biasing means having sufficient biasing force for maintaining the lip of a fish between the front ends of the upper and lower members when the holding device is in the closed position, said biasing means being located between the upper and lower members; and
a rear section having means for locking the holding device in the closed position, said locking means being rotatably connected to the rear end of the lower member and comprising tab means for connection with the rear end of the upper member, whereby when the holding device is in the closed position the locking means is rotatably positioned on and the tab means is connected to the upper member and the lip of the fish is immoveably secured between the front ends of the upper and lower members, and when the tab means is disconnected from the upper member, the locking means is rotated away from the upper member and the front ends of the upper and lower members can be separated to open and to release the fish from the device.

2. The fish holding device as in claim 1 further comprising a slot in the upper member into which the tab means is inserted when the holding device is in a closed position.

3. The fish holding device as in claim 1 wherein the locking means comprises an arm member rotatably connected to the rear end of the bottom member.

4. The fish holding device as in claim 3 further comprising a second arm member extending from and angled in relation to the arm member, the tab means extending from the second arm member.

5. The fish holding device as in claim 3 further comprising support means extending from the arm for assisting in maintaining the lip of the fish between the upper and lower members when the clip is in the closed position.

6. The fish holding device as in claim 1 further comprising support means extending from the locking means for assisting in maintaining the lip of the fish between the upper and lower members when the clip is in the closed position.

7. A fish holding device for use in culling fish comprising:
a forward section having an upper member with a rear end and a front end, a lower member with a rear end and a front end, and biasing means having sufficient biasing force for maintaining the lip of a fish between the front ends of the upper and lower members when the holding device is in the closed position, said biasing means being located between the upper and lower members; and
a rear section having means for locking the holding device in the closed position, said locking means being rotatably connected to the rear end of the lower member, whereby when the holding device is in the closed position, the locking means is rotatably positioned on the upper member and the lip of the fish is immoveably secured between the front ends of the upper and lower members, and when the locking means is rotated off the upper member, the front ends of the upper and lower members can be separated to open and to release the fish from the holding device.

8. The fish holding device as in claim 7 further comprising an arm member rotatably connected to the rear end of the bottom member, a tab extending from the arm member, and a slot at the rear end of the upper member into which the tab means is inserted when the device is in a closed position.

9. The fish holding device as in claim 8 further comprising support means extending from the arm for assisting in maintaining the lip of the fish between the upper and lower members when the clip is in a closed position.

10. The fish holding device as in claim 7 further comprising support means extending from the locking means for assisting and maintaining the lip of the fish between the upper and lower members when the device is in a closed position.
